(19) United States
(12) Patent Application Publication
(10) Pub. No.: US 2005/0149605 A1
(43) Pub. Date: Jul. 7, 2005

(54) Method for matching information exchange on network

(76) Inventor: Hsiao-Lien Wang, Chung-Li (TW)

Correspondence Address: Hsu & Associates, P.O. Box 72, Nankang, Taipei, TW

(21) Appl. No.: 10/741,178

(22) Filed: Dec. 19, 2003

(51) Int. Cl. G06F 15/16

(52) U.S. Cl. 709/200

(57) ABSTRACT

A method of matching the information supply/demand to the information demand/supply on network is disclosed. The method includes the step of using a server to collect the expression of the information supply/demand which is a weighted or non-weighted word units set. The method includes the other step of using a server to collect the expressions of the information demand/supply which is a weighted or non-weighted word units set, a searching keyword, or a computer address. The method includes another step of matching the expression of information supply/demand to the expression of information demand/supply. There are three ways to do the matching: 1) similarity measurement, 2) keywords searching, 3) expressions presenting.

### BACKGROUND OF THE INVENTION

1. Field of the Invention

This invention relates generally to the method of matching the information supply/demand to the information demand/supply on network. More specifically, this invention relates to the expressions as well as the way of matching the expressions of the information supply and the information demand on network.

2. Description of the Related Art

In the real world, there are numerous computers connected on network. Each computer may have many information supplies to or many information demands from other computers. To accomplish the exchange of information supplies and information demands, the information supplies should be matched to the proper information demands first. There have mainly two prior art methods been using to match information supplies to information demands on network. In one prior art method, which can be referred to as “keyword search method”, the information supply is expressed as a narrative document, the information demand is expressed as a string of keywords combined by “AND, OR, NOT” operators, and the way of matching is to make a keyword search on the document. WWW and peer to peer file exchange platform like ezpeer and KURO are examples that have been using this prior art method. In the other prior art method, which can be referred to as “data base query method”, the information supply is expressed as a database record, the information demand is expressed as a database query, and the way of matching is to make a database retrieving. A lot of e-commerce businesses are examples that have been using this prior art method.

Although these prior art methods have been widely applied in many systems to match information supply to information demand, they still have some inefficiencies and these inefficiencies result in inconveniences on and limit the scope of the methods' application. With regard to the keyword search method, the inefficiency occurs when there is an information overloading for the matching result. The problem comes from that the overloaded matching result can not be arranged in order according to the appropriateness or the emphasis directly. As for the database query method, the inefficiency exists in that a framework has to be specified first for the expressions of the information supply and the information demand. Thus, the scope of the application is limited.

It is desirable to provide a method for matching the information supply to the information demand on network and the mentioned method can provide a matching result that can be sorted directly. It is also desirable to provide a method for matching the information supply to the information demand on network and the mentioned method can be applied without specifying a framework for the expression of the information supply or the information demand.

### SUMMARY OF THE INVENTION

The invention is directed to a method of matching the information supply/demand to the information demand/supply on network. In accordance with the invention, the method includes the step of using a server to collect the expression of the information supply. The expression of the information supply can be a weighted word units set or a non-weighted word units set. A weighted word units set is a string of weighted word units separated by a symbol; and a non-weighted word units set is a string of word units separated by a symbol. The word unit can be a single word, a term, a “NOT” symbol headed word/term, or a “OR” symbol connected words/terms. The method includes the other step of using a server to collect the expression of the information demand. The expression of the information demand can be a weighted word units set or a non-weighted word units set, a searching keywords known in the art, or a computer's address. The method includes another step of matching the information supply to the information demand. Making use of the collected expressions, there are three ways to do the matching. 1) Similarity measurement: the matching can be done by measuring the similarity between the two word units sets expressed as the information supply and the information demand individually. Since the word units sets basically are two strings of words and terms, many familiarized formulas for measuring document similarity can be applied. 2) Keywords searching: the matching can be done by using the keywords expressed as the information demand to make a keywords search known in the art on the weighted word units set or the non-weighted word units set expressed as the information supply. 3) Expression presenting: making use of the computer address expressed as the information demand, the matching can be done by presenting the weighted word units set or the non-weighted word units set expressed as the information supply to the information demander.

### BRIEF DESCRIPTION OF THE DRAWINGS

The present invention can be more fully understood by reference to the following description and accompanying drawings, in which:

FIG. 1 is a diagrammatic view of matching information supplies to information demands on network in accordance with one embodiment of the invention;

FIG. 2 is an example of the weighted word units set;

FIG. 3 is a formula for counting the score of similarity between two documents;

FIG. 4 is an example of the matching result which is a series of weighted word units sets; and

FIG. 5 is flow chart showing a method of matching the information supply/demand to the information demand/supply on network in accordance with one embodiment of the invention.

### DETAILED DESCRIPTION OF THE PREFERRED EMBODIMENTS

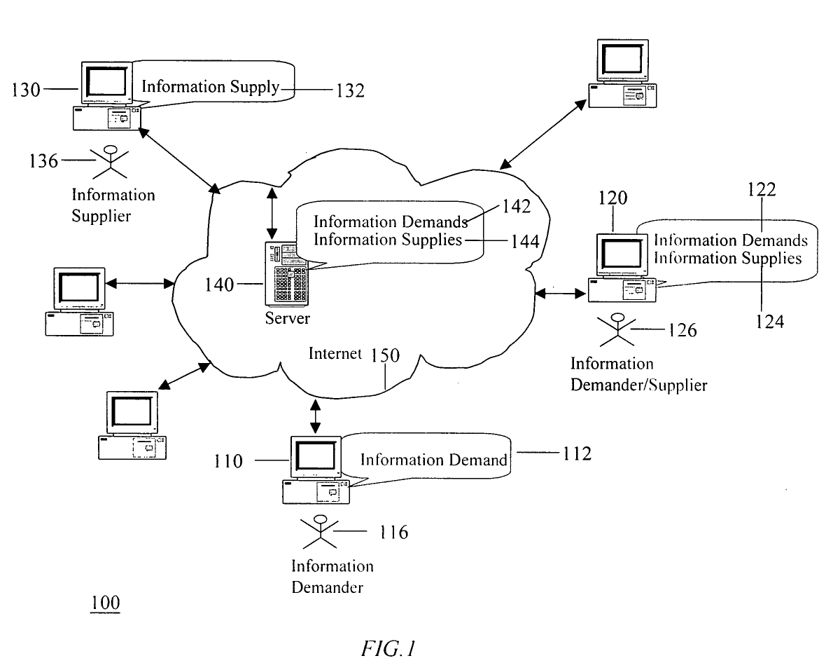

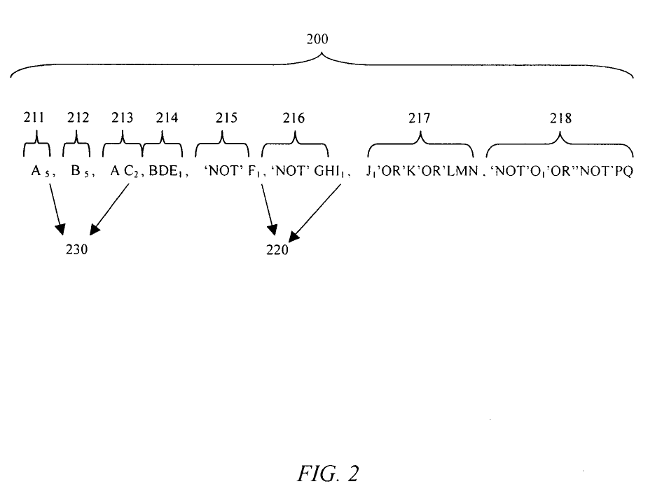

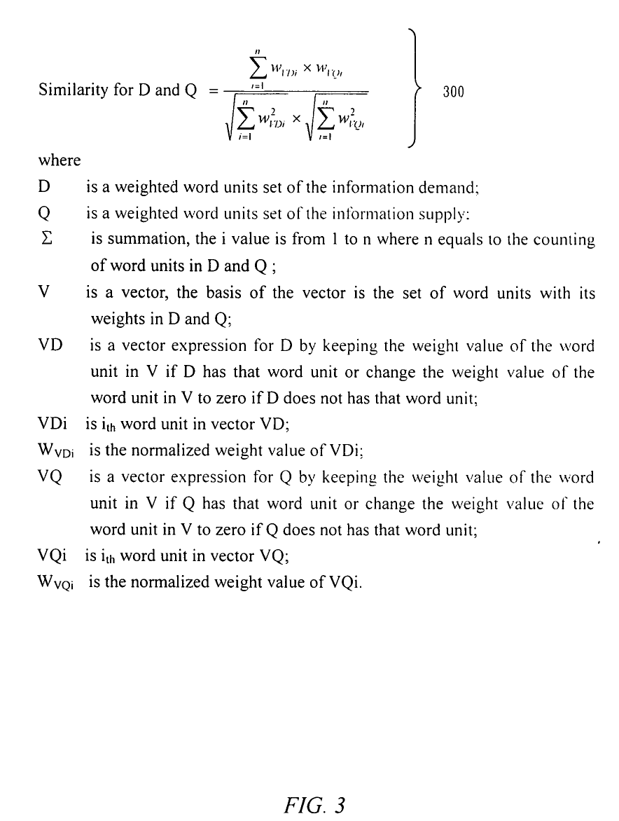

The invention is directed to the matching of information supplies/demands to information demands/supplies for information exchange on network. FIG. 1 shows a diagrammatic view 100 of matching information supplies/demands to information demands/supplies on network in accordance with the preferred embodiment of the invention, wherein many computers are connected on internet 150 and the computers 110, 120, 130 operated by the users 116, 126, 136 have information demands 112, 122 and information supplies 124, 132 to be matched. In accordance with the preferred embodiment of the invention, the method includes the step of using a server 140 to collect the expression of the information supply 124, 132 on internet 150. The expression of the information supply 124, 132 can be a weighted word units set or a non-weighted word units set. FIG. 2 shows an example of the weighted word units set 200. A weighted word units set 200 is a string of word units 211, 212, 213, 214, 215, 216, 217, 218 separated by a symbol 220, wherein each one of the word units 211, 212, 213, 214, 215, 216, 217, 218 is a selection from a data set that comprise a word, a term, and a OR-connected word which consists of many words and terms connected by a “OR” symbol to mean that these words and terms have the same meaning and one of them is to be used. A word unit further can have a selection from a sign set that comprises a “NOT” and a “ ” symbol with it. The word unit with a “NOT” symbol is a negative expression of the word unit in the weighted word units set; the word unit with a “ ” symbol is a positive expression of the word unit in the weighted word units set. Used in the expression of the information supply and the information demand, a word unit comes to be one of the following four forms with weight 230 given to show the importance of the word unit in the weighted word units set 200: 1) a single word 211, 212, for example, flower; 2) a term 213, 214 being composed of many words, for example, beautiful flower; 3) a “NOT” symbol headed word/term 215, 216, for example, “NOT” flower; 4) a “OR” symbol connected words/terms 217, 218, for example, flower “OR” beautiful flower. A non-weighted word units set is totally identical to a weighted word units set 200 except that no weight 230 is given to any one of the word units 211, 212, 213, 214, 215, 216, 217, 218. In accordance with the preferred embodiment of the invention, the method also includes the step of using a server 140 to collect the expression of the information demand 112, 122 on internet 150. The expression of the information demand 112, 122 can be a weighted word units set or a non-weighted word units set, a searching keywords known in the art, or a computer's address on internet. As familiarized keywords searching, the structure of a searching keyword is a string of words combined by operators, the operator is a selection from an operator set comprises the “AND” “OR” “NOT” operators. Further, the word has a selection from a mark set which comprises the parenthesis and the empty set. In accordance with the preferred embodiment of the invention, the method includes another step of matching the expression of the information supply 124, 132 to the expression of the information demand 112, 122. Making use of the different types of expressions collected 142, 144, there are three ways to perform the matching. 1) Similarity measurement: the matching is decided by measuring the similarity between the expressions of the information supply and the information demand. Since the expressions of the information supply and the information demand can both be word units sets which basically are two strings of words and terms, many familiarized formulas for measuring document similarity can be applied. One popular formula 300 is shown in FIG. 3. If both expressions of the information supply and the information demand are weighted word units sets, the formula can be applied directly. If both expressions of the information supply and the information demand are non-weighted word units sets, or one expression is a weighted word units set and the other expression is a non-weighted word units set, the formula still can be applied while setting an equal weight for every word unit in the expressions. In using the formula, the weight value for the two expressions should be normalized to fall into a certain range, for example, between zero and one. 2) Keywords searching: the matching can be decided by using the keywords expressed as the information demand to make a keywords search known in the art on the weighted word units set or the non-weighted word units set expressed as the information supply. 3) Expression presenting: making use of the computer address expressed as the information demand, the matching can be done by presenting the weighted word units sets or the non-weighted word units sets expressed as the information supplies 124, 132 to the information demander 116, 126 on internet.

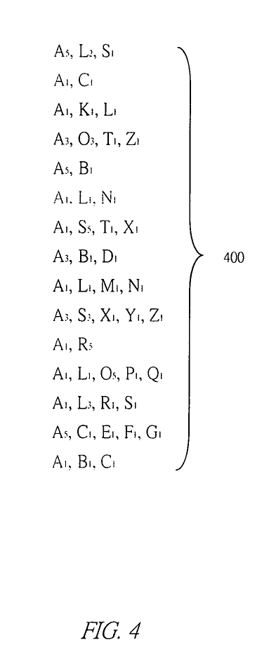

In accordance with the invention, the expression of information demand/supply is not restricted within any framework or limited to any scope. The matching result for an information demand to many information supplies, or an information supply to many information demands can be a series of weighted word units sets or non-weighted word units sets. Both of the matching results can be arranged in order according to appropriateness or emphasis directly. If the matching result is a series of weighted word units sets 400 as FIG. 4 shows, score of similarity can be measured and sorting can be applied on the score of similarity. In addition to similarity score, sorting can be applied on the word unit's weight together with alphabet. If the matching result is a series of non-weighted word units sets, score of similarity still can be measured by setting an equal weight to all word units and sorting on the score of similarity can be applied.

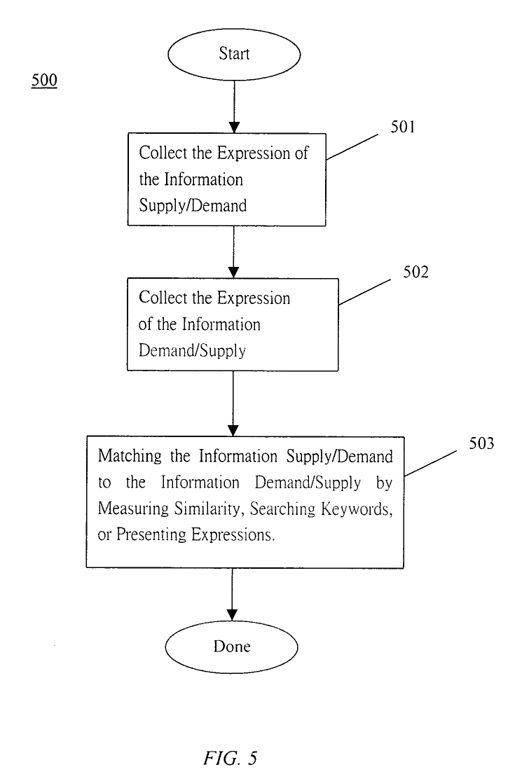

FIG. 5 shows a flowchart of the method 500 according to the invention. The method 500 relates to matching the information supply/demand to the information demand/supply on network. The process begins with the step of using a server to collect the expression of the information supply/demand 501. The next step is to use a server to collect the expression of the information demand/supply 502. The next step includes matching the information supply/demand to the information demand/supply by making use of the expressions of the information supply and demand to perform similarity measuring, keywords searching or expressions presenting 503.

The invention may be embodied in other specific forms without departing from the spirit or essential characteristics as described herein. Therefore, the present embodiments are to be considered in respects as illustrative and not restrictive. Accordingly, the invention shall be limited in scope only by the attached claims. All changes, which come within the meaning and range of the equivalency of the claims, are therefore intended to be embraced therein.

1. A method for matching information exchange on network, the method comprising:
A. using a server to collect the expression of the information supply on network, said expression of the information supply consists of a string of at least two words separated by a symbol;
B. using a server to collect the expression of the information demand on network, said expression of the information demand consists of a string of at least two words separated by a symbol; and
C. matching the information supply to the information demand, said matching is decided by similarity measurement between the said expression of the information supply and the said expression of the information demand.

2. The method for matching information exchange according to claim 1 wherein said similarity measurement is done by the following formula while setting an equal weight for the said word:
similarity for D and Q=(Σ(W_{VDi}×W_{VQi}))÷((√W²_{VDi})×(√ΣW²_{VQi}))
where
D is the said expression of the information demand;
Q is the said expression of the information supply;
Σ is summation, the i value is from 1 to n where n equals to the counting of said words in both D and Q;
V is a vector, the basis of the vector is the set of said words with its weights in D and Q;
VD is a vector expression for D by keeping the weight value of the word in V if D has that word or change the weight value of the word in V to zero if D does not has that word;
VDi is iₜₕ word in vector VD;
W_{VDi} is the normalized weight value of VDi;
VQ is a vector expression for Q by keeping the weight value of the word in V if Q has that word or change the weight value of the word in V to zero if Q does not has that word;
VQi is iₜₕ word in vector VQ;
W_{VQi} is the normalized weight value of VQi.

3. The method for matching information exchange according to claim 1, wherein said word further has a weight to show the importance of the said word in the said expression;
said similarity measurement is done by the following formula:
similarity for D and Q=(Σ(W_{VDi}×W_{VQi}))÷((√W²_{VDi})×(√W²_{VQi}))
where
D is the said expression of the information demand;
Q is the said expression of the information supply;
Σ is summation, the i value is from 1 to n where n equals to the counting of said words in both D and Q;
V is a vector, the basis of the vector is the set of said words with its weights in D and Q;
VD is a vector expression for D by keeping the weight value of the word in V if D has that word or change the weight value of the word in V to zero if D does not has that word;
VDi is iₜₕ word in vector VD;
W_{VDi} is the normalized weight value of VDi;
VQ is a vector expression for Q by keeping the weight value of the word in V if Q has that word or change the weight value of the word in V to zero if Q does not has that word;
VQi is iₜₕ word in vector VQ;
W_{VQi} is the normalized weight value of VQi.

4. The method for matching information exchange according to claim 1, wherein said word further has a selection from a sign set, said sign set comprises the symbol “NOT” and the symbol “ ”, said symbol “NOT” means that the said word is negative in the said expression, said symbol “ ” means that the said word is positive in the said expression.

5. The method for matching information exchange according to claim 2, wherein said word further has a selection from a sign set, said sign set comprises the symbol “NOT” and the symbol “ ”, said symbol “NOT” means that the said word is negative in the said expression, said symbol “ ” means that the said word is positive in the said expression.

6. The method for matching information exchange according to claim 3, wherein said word further has a selection from a sign set, said sign set comprises the symbol “NOT” and the symbol “ ”, said symbol “NOT” means that the said word is negative in the said expression, said symbol “ ” means that the said word is positive in the said expression.

7. A method for matching information exchange on network, the method comprising:
A. using a server to collect the expression of the information supply on network, said expression of the information supply consists of a string of at least two word units separated by a symbol; said word unit is a selection from a data set, said data set comprises a word and a term;
B. using a server to collect the expression of the information demand on network, said expression of the information demand consists of a string of at least two word units separated by a symbol; said word unit is a selection from a data set, said data set comprises a word and a term; and
C. matching the information supply to the information demand, said matching is decided by similarity measurement between the said expression of the information supply and the said expression of the information demand.

8. The method for matching information exchange according to claim 7, wherein said similarity measurement is done by the following formula while setting an equal weight for the said word unit:
similarity for D and Q=(Σ(W_{VDi}×W_{VQi}))÷((√W²_{VDi})×(√ΣW²_{VQi}))
where
D is the said expression of the information demand;
Q is the said expression of the information supply;
Σ is summation, the i value is from 1 to n where n equals to the counting of said word units in both D and Q;
V is a vector, the basis of the vector is the set of said word units with its weights in D and Q;
VD is a vector expression for D by keeping the weight value of the word unit in V if D has that word unit or change the weight value of the word unit in V to zero if D does not has that word unit;
VDi is iₜₕ word unit in vector VD;
W_{VDi} is the normalized weight value of VDi;
VQ is a vector expression for Q by keeping the weight value of the word unit in V if Q has that word unit or change the weight value of the word unit in V to zero if Q does not has that word unit;
VQi is iₜₕ word unit in vector VQ;
W_{VQi} is the normalized weight value of VQi.

9. The method for matching information exchange according to claim 7, wherein said word unit further has a weight to show the importance of the said word unit in the said expression; said similarity measurement is done by the following formula:
similarity for D and Q=(Σ(W_{VDi}×W_{VQi}))÷((√W²_{VDi})×(√ΣW²_{VQi}))
where
D is the said expression of the information demand;
Q is the said expression of the information supply;
Σ is summation, the i value is from 1 to n where n equals to the counting of said word units in both D and Q;
V is a vector, the basis of the vector is the set of said word units with its weights in D and Q;
VD is a vector expression for D by keeping the weight value of the word unit in V if D has that word unit or change the weight value of the word unit in V to zero if D does not has that word unit;
VDi is iₜₕ word unit in vector VD;
W_{VDi} is the normalized weight value of VDi;
VQ is a vector expression for Q by keeping the weight value of the word unit in V if Q has that word unit or change the weight value of the word unit in V to zero if Q does not has that word unit;
VQi is iₜₕ word unit in vector VQ;
W_{VQi} is the normalized weight value of Vqi.

10. The method for matching information exchange according to claim 7, wherein said word unit further has a selection from a sign set, said sign set comprises the symbol “NOT” and the symbol “ ”, said symbol “NOT” means that the said word unit is negative in the said expression, said symbol “ ” means that the said word unit is positive in the said expression.

11. The method for matching information exchange according to claim 8, wherein said word unit further has a selection from a sign set, said sign set comprises the symbol “NOT” and the symbol “ ”, said symbol “NOT” means that the said word unit is negative in the said expression, said symbol “ ” means that the said word unit is positive in the said expression.

12. The method for matching information exchange according to claim 9, wherein said word unit further has a selection from a sign set, said sign set comprises the symbol “NOT” and the symbol “ ”, said symbol “NOT” means that the said word unit is negative in the said expression, said symbol “ ” means that the said word unit is positive in the said expression.

13. A method for matching information exchange on network, the method comprising:
A. using a server to collect the expression of the information supply on network, said expression of the information supply consists of a string of at least two word units separated by a symbol; said word unit is a selection from a data set, said data set comprises a word and a term;
B. using a server to collect the expression of the information demand on network, said expression of the information demand is a string of at least one words combined by operators, said operator is a selection from operator set, said operator set comprises the “AND” operator, the “OR” operator and the “NOT” operator; said word further has a mark, said mark is a selection from mark set, said mark set comprises the parenthesis and the empty set; and
C. matching the information supply to the information demand, said matching is decided by making use of the said expression of the information demand to make a familiarized keyword search on the said expression of the information supply.

14. The method for matching information exchange according to claim 13, wherein said word unit further has a selection from a sign set, said sign set comprises the symbol “NOT” and the symbol “ ”, said symbol “NOT” means that the said word unit is negative in the said expression, said symbol “ ” means that the said word unit is positive in the said expression.

15. The method for matching information exchange according to claim 13, wherein said word unit further has a weight to show the importance of the said word unit in the said expression.

16. A method for matching information exchange on network, the method comprising:
A. using a server to collect the expression of the information supply on network, said expression of the information supply consists of a string of at least two word units separated by a symbol; said word unit is a selection from a data set, said data set comprises a word and a term;
B. using a server to collect the expression of the information demand on network, said expression of the information demand is a computer address; and
C. matching the information supply to the information demand by presenting the said expression of the information supply to the information demander.

17. The method for matching information exchange according to claim 16, wherein said word unit further has a selection from a sign set, said sign set comprises the symbol “NOT” and the symbol “ ”, said symbol “NOT” means that the said word unit is negative in the said expression, said symbol “ ” means that the said word unit is positive in the said expression.

18. The method for matching information exchange according to claim 16, wherein said word unit further has a weight to show the importance of the said word unit in the said expression.
